(19) United States
(12) Patent Application Publication
(10) Pub. No.: US 2018/0075421 A1
(43) Pub. Date: Mar. 15, 2018

(54) LOAN PROCESSING SERVICE UTILIZING A DISTRIBUTED LEDGER DIGITAL ASSET AS COLLATERAL

(71) Applicant: BitPagos, Inc., Wilmington, DE (US)

(72) Inventors: Sebastian Serrano, Buenos Aires (AR); Luciana Marcela Gruszeczka, Buenos Aires (AR); Mugur Marculescu, Palo Alto, CA (US)

(21) Appl. No.: 15/697,799

(22) Filed: Sep. 7, 2017

Related U.S. Application Data
(60) Provisional application No. 62/385,291, filed on Sep. 9, 2016.

(51) Int. Cl. G06Q 20/10; G06Q 40/02; G06Q 20/40; G06Q 20/24; H04L 29/06

(52) U.S. Cl. CPC G06Q 20/105; G06Q 40/025; H04L 63/061; G06Q 20/24; G06Q 20/401

(57) ABSTRACT

Systems, methods, and computer-readable media for a loan processing service utilizing a distributed ledger digital asset as collateral are provided.

### CROSS-REFERENCE TO RELATED APPLICATION(S)

This application claims the benefit of prior filed U.S. Provisional Patent Application No. 62/385,291, filed Sep. 9, 2016, which is hereby incorporated by reference herein in its entirety.

### TECHNICAL FIELD

This disclosure relates to a loan processing service utilizing a distributed ledger digital asset as collateral.

### BACKGROUND OF THE DISCLOSURE

Conventional loan processing services have several disadvantages including, but not limited to, high transaction fees and volatility tied to centralized currency systems.

### SUMMARY OF THE DISCLOSURE

This document describes systems, methods, and computer-readable media for a loan processing service utilizing a distributed ledger digital asset as collateral.

For example, a method may include obtaining at a loan processing subsystem a distributed ledger digital asset from a distributed ledger digital asset network subsystem, receiving at the loan processing subsystem a loan request, determining at the loan processing subsystem a loan structure based on the received loan request, transmitting at least a portion of the obtained distributed ledger digital asset from the loan processing subsystem to at least one of a merchant client subsystem and a customer client subsystem based on the determined loan structure, and receiving a fiat money asset at the loan processing subsystem from at least one of the customer client subsystem and a fiat money asset network subsystem based on the determined loan structure.

As another example, a loan processor subsystem may include a communications component and a processor operative to obtain, via the communications component, a distributed ledger digital asset from a first remote subsystem, receive, via the communications component, a loan request, determine a loan structure based on the received loan request, transmit, via the communications component, at least a portion of the obtained distributed ledger digital asset to a second remote subsystem based on the determined loan structure, and receive, via the communications component, a fiat money asset from a third remote subsystem based on the determined loan structure.

As yet another example, a non-transitory computer-readable medium may include computer-readable instructions recorded thereon for obtaining at a loan processing subsystem a distributed ledger digital asset from a distributed ledger digital asset network subsystem, receiving at the loan processing subsystem a loan request, determining at the loan processing subsystem a loan structure based on the received loan request, transmitting at least a portion of the obtained distributed ledger digital asset from the loan processing subsystem to at least one of a merchant client subsystem and a customer client subsystem based on the determined loan structure, and receiving a fiat money asset at the loan processing subsystem from at least one of the customer client subsystem and a fiat money asset network subsystem based on the determined loan structure.

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system for a loan processing service of the disclosure;

FIG. 2 is a more detailed schematic view of a client subsystem of the system of FIG. 1; and

FIGS. 3-7 are flowcharts of illustrative processes for providing features of the service of the disclosure.

### DETAILED DESCRIPTION OF THE DISCLOSURE

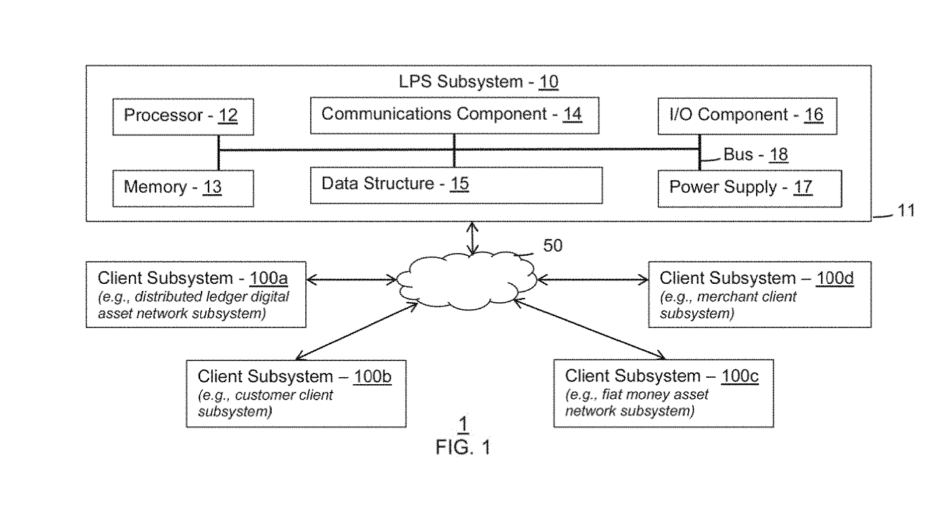

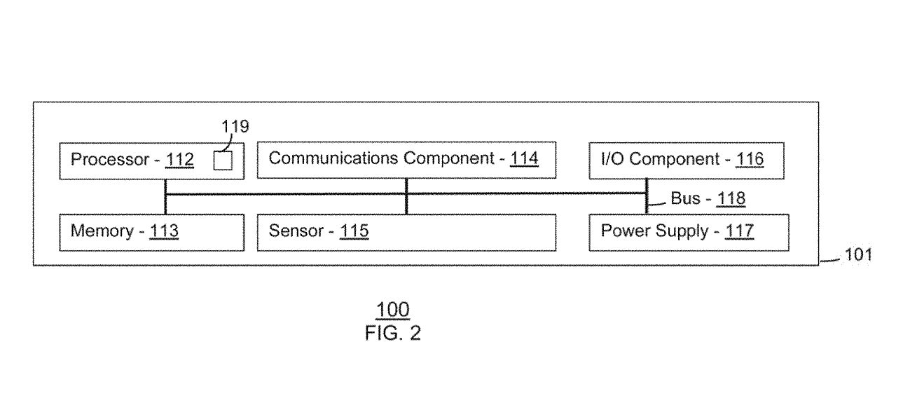

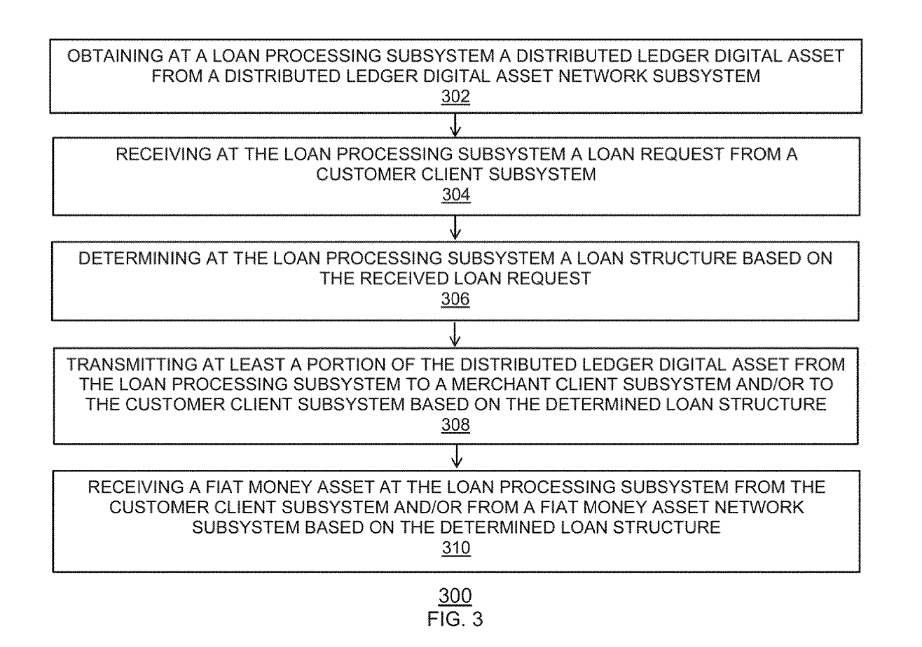

FIG. 1 shows a system 1 in which a loan processing service utilizing a distributed ledger digital asset as collateral may be facilitated amongst various client subsystems 100, FIG. 2 shows further details with respect to a particular embodiment of a client subsystem 100 of system 1, and FIGS. 3-7 are flowcharts of illustrative processes for using the loan processing service.

### Description of FIG. 1 and FIG. 2

FIG. 1 is a schematic view of an illustrative system 1 in which loan processing may be facilitated utilizing distributed ledger digital assets (e.g., a decentralized currency or currency issued by decentralized distributed ledgers and/or by centralized distributed ledgers). For example, as shown in FIG. 1, system 1 may include a loan processing service (“LPS”) subsystem 10, various client subsystems 100 (e.g., client subsystems 100a-100d), and a communications network 50 through which LPS subsystem 10 and at least one client subsystem 100 may communicate.

As shown in FIG. 2, and as described in more detail below, a client subsystem 100 may include a processor component 112, a memory component 113, a communications component 114, a sensor 115, an input/output (“I/O”) component 116, a power supply component 117, and/or a bus 118 that may provide one or more wired or wireless communication links or paths for transferring data and/or power to, from, or between various other components of client subsystem 100. I/O component 116 may include at least one input component (e.g., button, mouse, keyboard) to receive information from a user and/or at least one output component (e.g., audio speaker, video display, haptic component) to provide information to a user, such as a touch screen that may receive input information through a user's touch of a display screen and that may also provide visual information to a user via that same display screen. Memory 113 may include one or more storage mediums, including for example, a hard-drive, flash memory, permanent memory such as read-only memory (“ROM”), semi-permanent memory such as random access memory (“RAM”), any other suitable type of storage component, or any combination thereof. Communications component 114 may be provided to allow client subsystem 100 to communicate with one or more other subsystems 100 or servers or LPS 10 using any suitable communications protocol (e.g., via communications network 50). Communications component 114 can be operative to create or connect to a communications network (e.g., network 50). Communications component 114 can provide wireless communications using any suitable short-range or long-range communications protocol, such as Wi-Fi (e.g., a 802.11 protocol), Bluetooth, radio frequency systems (e.g., 1200 MHz, 2.4 GHz, and 5.6 GHz communication systems), infrared, protocols used by wireless and cellular telephones and personal e-mail devices, or any other protocol supporting wireless communications. Communications component 114 can also be operative to connect to a wired communications network or directly to another data source wirelessly or via one or more wired connections. Sensor 115 may be any suitable sensor that may be configured to sense any suitable data for device 100 (e.g., location-based data via a GPS sensor system). Power supply 117 can include any suitable circuitry for receiving and/or generating power, and for providing such power to one or more of the other components of client subsystem 100. Client subsystem 100 may also be provided with a housing 101 that may at least partially enclose one or more of the components of client subsystem 100 for protection from debris and other degrading forces external to client subsystem 100. Each component of client subsystem 100 may be included in the same housing 101 (e.g., as a single unitary device, such as a laptop computer or portable media device) and/or different components may be provided in different housings (e.g., a keyboard input component may be provided in a first housing that may be communicatively coupled to a processor component and a display output component that may be provided in a second housing). In some embodiments, client subsystem 100 may include other components not combined or included in those shown or several instances of the components shown.

Processor 112 may be used to run one or more applications, such as an application 119 that may be accessible from memory 113 and/or any other suitable source (e.g., from network 50 via LPS subsystem 10 or any other subsystem and an active internet connection). Application 119 may include, but is not limited to, one or more operating system applications, firmware applications, communication applications, internet browsing applications (e.g., for interacting with a website provided by LPS subsystem 10 for enabling client subsystem 100 to interact with an online service), loan processing applications (e.g., a web application or a native application that may be at least partially produced by LPS subsystem 10 for enabling client subsystem 100 to interact with an online service), or any other suitable applications. For example, processor 102 may load an application 119 as a user interface program to determine how instructions or data received via an input component of I/O component 116 or other component of client subsystem 100 may manipulate the way in which information may be stored and/or provided to the user via an output component of I/O component 116. As one example, application 119 may provide a user with the ability to interact with a loan processing service or payment processing service platform (“LPSP”) of LPS subsystem 10, where application 119 may be a third party application that may be running on client subsystem 100 (e.g., an application associated with LPS subsystem 10) that may be loaded on client subsystem 100 via an application market, such as the Apple App Store or Google Play, or that may be accessed via an internet application or web browser (e.g., by Apple Safari or Google Chrome) that may be running on client subsystem 100 and that may be pointed to a uniform resource locator (“URL”) whose target or web resource may be managed by or otherwise affiliated with LPS subsystem 10.

LPS subsystem 10 may include a processor component 12 that may be similar to processor 112, a memory component 13 that may be similar to memory component 113, a communications component 14 that may be similar to communications component 114, an I/O component 16 that may be similar to I/O component 116, a power supply component 17 that may be similar to power supply component 117, and/or a bus 18 that may be similar to bus 118. Moreover, LPS subsystem 10 may include one or more data sources or data structures 15 that may include any suitable data and/or applications (e.g., application 119 of a subsystem 100 and/or an application that may be run by processor 12 of LPS subsystem 10) for facilitating a loan processing service or LPSP that may be provided by LPS subsystem 10 to one or more client subsystems 100. Some or all portions of LPS subsystem 10 may be operated, managed, or otherwise at least partially controlled by an entity responsible for providing a loan processing service to one or more users or entities.

LPS subsystem 10 may communicate with one or more client subsystems 100 via communications network 50 and/or any client subsystem 100 may communicate with any other client subsystem 100 via communications network 50. Network 50 may be the internet or any other network, such that when interconnected, a client subsystem 100 may access information (e.g., from data structure 15 of LPS subsystem 10, as may be provided as a loan processing service via processor 12 of LPS subsystem 10) as if such information were stored locally at that client subsystem 100 (e.g., in memory component 113).

LPS subsystem 10 may be operative to provide loan processing services to customers that may wish to make payments to merchants as a distributed ledger digital asset (e.g., as a digital cryptocurrency or digital money (e.g., bitcoin from a block chain or distributed ledger of a decentralized network or Citicoin from a block chain or distributed ledger or distributed database of one or more centralized networks (e.g., of Citibank or of any other institution and/or its agents))) rather than as a fiat money asset (e.g., as a real currency or real money government currency (e.g., U.S. dollars (“USD”), pesos, etc.)). Therefore, both decentralized distributed ledger digital assets and centralized distributed ledger digital assets may be provided as a loan to customers by LPS subsystem 10. Any suitable distributed ledger technology may be utilized, such as sidechain technology with public or private networks and/or alternate blockchains within public or private environments.

As one example of such a distributed ledger digital asset, a bitcoin (with a lowercase “b”) may be a unit of virtual currency that may depend on a computer protocol called Bitcoin (with a capital “B”) for its distributed global ledger. Bitcoin (the protocol) may not be administered by any central authority. That is, there may be no middleman between the sender and receiver. In fact, there may be no company or agent thereof or even an individual responsible for the administration of the Bitcoin protocol. A single unit of value, a bitcoin, may not be a promise by any central authority to pay its worth in gold or any other commodity. Bitcoin may thus be referred to as a “decentralized” digital currency or a digital asset from a distributed ledger of a decentralized network. In lieu of a central authority, the Bitcoin protocol may run on the Internet across hundreds of thousands or any other suitable number of computers that may securely and transparently settle and confirm transactions (e.g., many independent client subsystems 100a forming a decentralized Bitcoin network). Anyone with a home computer or mobile telephone may download the open-source software that may permit that computer to join the Bitcoin network, the network that may ensure that each user can save and spend the correct amount of bitcoin.

A Bitcoin user can transact directly with another Bitcoin user by means of their “Bitcoin addresses.” By way of these addresses, which could be correlated to what may be typically referred to as accounts, users of the Bitcoin network may send bitcoin back and forth, just as users of the United States dollar might exchange dollars back and forth. Bitcoins may be stored in a user's “digital wallet,” which may be a feature of the open-source software but also can be provided as a service by virtual currency wallet services and exchangers. Each of these wallets may be able to contain one or more Bitcoin addresses, each of which may be represented by a unique alphanumeric string of characters. To initiate a transaction, the user may simply click a button in or otherwise appropriately interact with the Bitcoin software to send a message to the other computers on the Bitcoin network announcing the transfer of a certain amount of bitcoins from the sender's address to a recipient's address. As payments can be initiated by a user and sent to another user without the intervention of any central authority standing between them, Bitcoin is known as a decentralized peer-to-peer network. These transactions may be protected by strong cryptographic security and verified by other Bitcoin network participants. The confirmation process may be mathematically complex, but it may be handled automatically and transparently to the users. From a user's perspective, sending and receiving bitcoin may be no more difficult than sending or receiving e-mail.

A user can communicate a Bitcoin address to another in a variety of ways, including, but not limited to, for example, by copying a Bitcoin address provided by the recipient into the Bitcoin software. Alternatively, some programs generate a Quick Response Code (“QR Code”) or any other suitable code that may contain a Bitcoin address. Another user may use Bitcoin wallet software on his or her mobile telephone, in conjunction with the camera of the telephone to scan the QR Code and record the other user's address. Once the sender has recorded the recipient's Bitcoin address, the sender may send bitcoin to the recipient over the Bitcoin network.

Due to Bitcoin's “decentralized” nature, it may be able to remain free from certain risks that government-backed currencies face. Bitcoin may not be subject to inflationary risks or currency controls by a central authority. Thus, Bitcoin can provide an alternative to residents of countries facing high rates of inflation or restrictive monetary policies. Fees may be almost or completely nonexistent in a Bitcoin transaction, regardless of whether the transaction is domestic or international. Many of the world's unbanked and under-banked populations are able to send and receive money at substantially lower costs with LPS subsystem 10 of system 1 than would be incurred using a traditional payment system. Merchants can also receive a higher percentage of their revenues because the fees may be less than those charged by a credit card company.

Like any other currency, users may obtain bitcoin from other users in exchange for goods or services. Many stores, restaurants, charities, and online businesses may accept bitcoin. Other users may obtain bitcoin by buying or trading for them via one of numerous bitcoin exchanges and other service providers that perform those functions.

Although bitcoin has been described, many other suitable types of distributed ledger digital asset may be utilized by the LPSP of LPS subsystem 10. While, in some embodiments, a distributed ledger digital asset (e.g., bitcoin) may be issued from a block chain or distributed ledger of a decentralized network (e.g., the Bitcoin network), in other embodiments, a distributed ledger digital asset (e.g., Citicoin) may be issued from a block chain or distributed ledger or distributed database of one or more centralized networks (e.g., a network of one or more endpoints (e.g., client subsystems 100a) managed by Citibank or any other institution alone or in combination with its agents (e.g., as a central authority administrator)). Therefore, one, some, or each reference to bitcoin or BTC or the like herein may refer to any suitable distributed ledger digital asset (“DLDA”).

LPS software (e.g., data structure or application 15) may act as a loan processing service layer that may be operative to connect a credit card payments processor or any other suitable fiat money asset payment processor with either a customer wishing to obtain a loan in bitcoins or any other distributed ledger digital asset but willing to pay back that loan with a credit card or other fiat money asset payments (e.g., in dollars) and/or with a merchant not wishing to take credit card or other fiat money asset payments (e.g., in dollars) but willing to receive bitcoins or any other distributed ledger digital asset instead of local or other currency from a customer. Therefore, LPS subsystem 10 may not be a money transmitter, but rather a loan payments processor, as the term “money transmitter” may not apply to an entity that only acts as a loan payment processor to facilitate the purchase or payment of a loan that may or may not be associated with a bill for a good or service through a clearance and settlement system by agreement with the creditor or seller, as LPS subsystem 10 may maintain contractual agreements with its loanee customers and/or with its merchants and/or may process loans and/or payments for them via a clearance and settlement system.

LPS subsystem 10 may be operative to come to terms on a loan agreement with a customer client (e.g., at operations 304 and 306 of process 300, described below). Then, LPS subsystem 10 may be operative to send (e.g., at operation 308 of process 300, described below) an agreed upon loan payout (e.g., loan principal) amount of any distributed ledger digital asset (e.g., bitcoins) directly to that customer client (e.g., to a customer client subsystem 100b) or to a merchant client (e.g., to a merchant client subsystem 100d) on behalf of that customer client (e.g., for a good or service from the merchant to the customer), where such distributed ledger digital asset may be sent from reserves of LPS subsystem 10, which may be previously obtained (e.g., at operation 302 of process 300, described below) by a distributed ledger digital asset network of one or more network subsystems (e.g., a distributed ledger digital asset network client subsystem 100a that may be operative to transfer bitcoin to LPS subsystem 10). Moreover, LPS subsystem 10 may be operative to receive in return from that customer client (e.g., at operation 310 of process 300, described below) one or more agreed upon loan payoff payments in fiat money asset (e.g., U.S. dollars) for paying off the loan payout amount (e.g., loan principal plus any agreed upon interest or otherwise that may be defined by the terms of the loan agreement and any exchange rate between the distributed ledger digital asset of the loan payout payment(s) and the fiat money asset of the loan payoff payment(s)). LPS subsystem 10 may be operative to clear the loan by receiving one or more loan payoff payments from the customer's credit card processor (e.g., from a fiat money asset network client subsystem 100c) and/or to settle the loan and/or a transaction by transmitting any distributed ledger digital asset to the customer and/or merchant client. This exchange may be a core function of LPS subsystem 10 and may allow for the processing of loans and/or transaction payments in the manner requested by the customer and/or merchant.

Additionally or alternatively, LPS subsystem 10 may be operative to accept and transmit funds only integral to the merchant sales. LPS subsystem 10 may make a loan enabling loan payout funds as distributed ledger digital assets to be transmitted to such a merchant for facilitating a merchant sale and enabling loan payoff funds as fiat money assets covering the loan to be received by LPS subsystem 10. The loan may be integral to the provision of the services provided by the merchant clients of LPS subsystem 10 because the loan payout funds may be a customer client's payment for a merchant client's goods and services. The goods or services provided by merchant clients may be any suitable goods or services, such as lodging (e.g., hotels).

In some embodiments, loan payout funds from LPS subsystem 10 may only flow to merchant clients, so customer clients may have no ability to direct that their loan payout funds go anywhere besides the merchant from which they are purchasing the good or service. LPS subsystem 10 may only send the merchant client sufficient value to complete the transaction (e.g., the value of the distributed ledger digital asset of the loan payout funds at the time of the transaction to the merchant may be equivalent to the value of the loan agreed to by the customer client and to the value of the good or service). In such embodiments, the terms of the loan agreement and the value of the customer/merchant transaction may be determined contemporaneously or in conjunction with one another by LPS subsystem 10 such that the value of the loan is directly tied to the value of the merchant good or service being purchased by the customer. Alternatively, rather than a loan agreement being associated with a specific customer/merchant transaction, where the loan payout funds may be sent from LPS subsystem 10 to the merchant, a loan agreement may be made without any association to any customer/merchant transaction, where the loan payout funds may be sent from LPS subsystem 10 to the customer and the customer may or may not use such loan payout funds for completing a customer/merchant transaction. LPS subsystem 10 may be operative to already possess the distributed ledger digital asset (e.g., bitcoins) to be sent out as the loan payout funds (e.g., to the merchant or to the customer) prior to any such loan payout fund transaction and/or prior to any receipt of any loan payoff funds (e.g., from the customer), such that LPS subsystem 10 may not be exchanging the customer client's money (e.g., loan payment funds) for the distributed ledger digital asset (e.g., bitcoins).

A value proposition of LPS subsystem 10 may provide various value to a customer client and/or to a merchant client. For example, LPS subsystem 10 may be operative to enable a merchant client to collect payment for goods or services in a distributed ledger digital asset (e.g., bitcoin) from a customer that may otherwise not have access to such a distributed ledger digital asset. By capturing shipping or customer data, LPS subsystem 10 may be operative to link a customer client to an otherwise anonymous distributed ledger digital asset payment. LPS subsystem 10 may be operative to helps merchants identify the source of the payments. LPS subsystem 10 may be operative to help a merchant to segregate the access and permissions between the clerks and administrator of an account. LPS subsystem 10 may be operative to help identify distributed ledger digital asset payments in every transaction. LPS subsystem 10 may be operative to help a merchant to convert their distributed ledger digital assets to local currencies with integrations to local exchanges. For example, LPS subsystem 10 may be operative to receive or define payment preferences from a merchant client (e.g., from a merchant client subsystem 100d) and may be operative to leverage such payment preferences to pay the merchant (e.g., at operation 308, described below) according to those preferences. For example, LPS subsystem 10 may identify that a merchant client prefers to be paid out for a transaction in a particular fiat money asset (e.g., government currency (e.g., centralized real money)). Therefore, rather than paying a merchant in distributed ledger digital asset (e.g., bitcoin) as loan payout funds after coming to terms on a loan agreement with a customer client (e.g., at operations 304 and 306 of process 300, described below), LPS subsystem 10 may provide merchant payment in distributed ledger digital asset (e.g., bitcoin) to a distributed ledger digital asset network subsystem (e.g., subsystem 100a) that may be operative to convert that distributed ledger digital asset payment into a fiat money currency payment aligned with the preferences of the merchant and send that fiat money currency payment to the merchant (e.g., directly from distributed ledger digital asset network subsystem 100a to merchant client subsystem 100d (via network 50) or from distributed ledger digital asset network subsystem 100a to LPS subsystem 10 and then to merchant client subsystem 100d (via network 50), all at operation 308 of process 300, as described below). One of many various available distributed ledger digital asset network subsystems 100a (e.g., a particular bitcoin exchange 100a) may be best suited to convert a distributed ledger digital asset into the currency desired by the merchant. Alternatively, LPS subsystem 10 may identify that a merchant client prefers to be paid out for a transaction in a particular distributed ledger digital asset, and LPS subsystem 10 may directly pay the merchant with the particular distributed ledger digital asset (e.g., bitcoin) as loan payout funds after coming to terms on a loan agreement with a customer client (e.g., merchant client subsystem 100d may be operative to receive such distributed ledger digital asset similarly to a distributed ledger digital asset network subsystem 100a). Distributed ledger digital asset payout to a merchant client by LPS subsystem 10 as loan payout funds on behalf of a loanee customer client may be made at a particular time directly to the merchant (e.g., in distributed ledger digital asset) or via a distributed ledger digital asset network subsystem 100a (e.g., in any desired fiat money currency). LPS subsystem 10 may be operative to help provide loan tools and, thus, transaction payment tools to facilitate charges with payment buttons, requests by e-mail, and mobile app payments (e.g., APIs or any other suitable tools for enabling a merchant client to provide a customer client with access to the services of LPS subsystem 10 (e.g., via a merchant's website or app running on a customer client subsystem 100b or via a point of sale terminal of a merchant client subsystem 100d operative to be interacted with by a customer client)). LPS subsystem 10 may be operative to help provide real-time quoting of prices in any distributed ledger digital asset and/or in any fiat money currencies and any exchange rates therebetween for enabling a transparent loan agreement and loan transaction process. LPS subsystem 10 may be operative to help a merchant give confidence on the business to consumers. Alternatively, such loan tools may be provided directly to a customer client subsystem by LPS subsystem 10 without any facilitation by a merchant client subsystem (e.g., via a LPS's website or app running on a customer client subsystem 100b or via a point of sale terminal of LPS subsystem 10 operative to be interacted with by a customer client)).

A service of LPS subsystem 10 may include the following example. A merchant client, such as an entity operative to control merchant client subsystem 100d, may be operative to sign up with LPS subsystem 10 to become an approved merchant of system 1 with the goal of using LPS subsystem 10 (e.g., software 15 of LPS subsystem 10) to form a loan agreement with a customer client and enabling loan payout funds to be received by the merchant client for facilitating customer/merchant transactions. The approval process may include collecting information about the owners, proof of address and business registration, and the like.

A customer client, such as an entity operative to control customer client subsystem 100b, that may wish to make a loan agreement with LPS subsystem 10 that may involve loan payout funds of a distributed ledger digital asset, which may be directed to a merchant client for purchasing a good or service from the merchant client (e.g., to pay for a hotel reservation), may be operative to do so by using a merchant website or app that may be operative to contain or run software of LPS subsystem 10 (e.g., via an application programming interface (“API”) or the like) or that may be operative to communicate with LPS subsystem 10 in any suitable way to facilitate the loan agreement and the payment of any loan payout fund and loan payoff funds in any suitable currency or currencies (e.g., in distributed ledger digital asset and/or in fiat money asset (e.g., via a credit card in the same manner as any other online credit card transaction)).

Software or any other suitable component of LPS subsystem 10 that may be incorporated into or leveraged by a website or app of a merchant client or of LPS subsystem 10 itself may facilitate a customer/merchant transaction in association with a loan agreement between LPS subsystem 10 and the customer. It may then send (e.g., by request of the merchant client) an appropriate amount of distributed ledger digital asset (e.g., an appropriate number of bitcoins) to the merchant client equal to the value of the loan payout (e.g., loan principal) of the loan agreement, where that loan payout value may be equal to the value of any fiat money asset currency to be paid by the customer client to LPS subsystem 10 as the loan payoff(s) of the loan agreement, perhaps minus any suitable processing fees or interest charges or otherwise for the benefit of LPS subsystem 10 (e.g., per the loan agreement).

Once the merchant client receives the distributed ledger digital asset (e.g., bitcoins), the merchant client can hold the distributed ledger digital asset, spend the distributed ledger digital asset, or convert the distributed ledger digital asset into local fiat money currency. At this point, there may be various technical options provided by system 1 for a merchant client to utilize the loan processing service of LPS subsystem 10. For example, an e-mail invoice (e.g., an indirect option) may be leveraged, whereby a merchant may have the choice of billing a customer via e-mail, where customers may click on a link on an invoice e-mail and enter the payment information themselves, which may be useful for remote pre-payments. As another example, a virtual terminal (e.g., a direct option) may be leveraged, whereby the merchant may log on to an online or via mobile device application of LPS subsystem 10 and collect a customer's payment and personal information via a web form, which may be useful for payments at the point of sale. As another example, API integration may be leveraged, whereby a merchant may be provided with a choice to integrate a portion of LPS subsystem 10 into the merchant's front end via an application interface.

With respect to the flow of funds, it is worth noting again that LPS subsystem 10 may be operative to never buy a distributed ledger digital asset (e.g., bitcoin) with merchant money and/or with customer money, and/or LPS subsystem 10 may be operative to never have merchant money in an operational account. One particular flow and/or settlement of a credit card transaction may include LPS subsystem 10 on behalf of and/or via a merchant client (e.g., of client subsystem 100d) being operative to receive an agreement to terms of a loan from a customer (e.g., from client subsystem 100b). Once a loan agreement is approved, LPS subsystem 10 may be operative to record the loan agreement (e.g., agreed loan payouts and agreed loan payoffs) on its account ledger and, whenever any loan payoff funds may be received by LPS subsystem 10 for the loan agreement, such loan payoff funds may be moved into an escrow account (e.g., memory 13 or any other suitable escrow location (e.g., third party subsystem) that may be used by LPS subsystem 10) with a payments aggregator of LPS subsystem 10 (e.g., from a fiat money asset network subsystem 100c or customer client subsystem 100b or otherwise to LPS subsystem 10). At a settlement date with the merchant, which may occur before or after any loan payoff funds are received, LPS subsystem 10 may be operative to determine the amount selected by the merchant to be settled to their distributed ledger digital asset wallet (e.g., bitcoin wallet) and LPS subsystem 10 may be operative to pay the merchant the equivalent of the selected amount with previously purchased distributed ledger digital asset (e.g., bitcoin), which may be obtained by LPS subsystem 10 from a distributed ledger digital asset network subsystem 100a (e.g., prior to forming a loan agreement with a customer client). For example, LPS subsystem 10 may be operative to pre-purchase distributed ledger digital assets (e.g., bitcoins) with funds of LPS subsystem 10 from an operational account and/or may store them in a buffer pool. LPS subsystem 10 may be operative to pay the merchant client a selected loan payoff amount minus any appropriate fees that LPS subsystem 10 may be configured to withdraw for its benefit. The payment may be at a rate valid within a settlement window. Then, the settlement may be complete. Any remaining unsettled funds may remain in escrow until the merchant chooses to settle them by repeating the previous operations.

One particular flow and/or settlement of a distributed ledger digital asset (e.g., bitcoin) transaction may include a merchant client of LPS subsystem 10 receiving a distributed ledger digital asset (e.g., bitcoin) payment from LPS subsystem 10 on behalf of a customer client of LPS subsystem 10. Such a distributed ledger digital asset (e.g., bitcoin) may be deposited into a temporary distributed ledger digital asset address created by or otherwise accessible to LPS subsystem 10 with a value equal to a loan payout amount after a loan agreement is reached between the customer client and the LPSP. After a confirmation or after any suitable number (e.g., three) of confirmations, LPS subsystem 10 may be operative to transfer the distributed ledger digital asset (e.g., bitcoins) from the temporary address to the merchant's distributed ledger digital asset (e.g., bitcoin) wallet, which may be hosted by LPS subsystem 10 (e.g., a merchant may have a Bitcoin wallet that may be hosted in one or more servers or other suitable portion of LPS subsystem 10) and/or merchants may have the choice to receive the bitcoins in their own wallets outside of servers of LPS subsystem 10. This transfer may occur before or after some or all agreed upon loan payoff funds of the loan agreement have been received by LPS subsystem 10. The total value of loan payoff funds to be collected by LPS subsystem 10 may be equal to or greater than the total value of the loan payout funds to be transferred by LPS subsystem 10 pursuant to any fees (e.g., interest and/or conversion fees) to be collected by LPS subsystem 10 in accordance with the terms of the loan agreement.

Therefore, in some embodiments, LPS subsystem 10 may be operative to stand between a merchant and its customers, forming a loan agreement to collect the customer's fiat money asset payments (e.g., government currency-denominated credit card payments) as loan payoff funds and to pay the merchant or the customer for the benefit of the merchant an equal value in distributed ledger digital asset (e.g., bitcoins) (or a lesser value due to any loan agreement fees due to the LPSP). LPS subsystem 10 may be operative to provide loan processing services for merchants that may wish to receive customer payments in a distributed ledger digital asset (e.g., bitcoin) instead of fiat money asset. Though LPS subsystem 10 may be operative in any suitable context, one particular area of use may be in serving the hotel industry in Latin American markets, such as Argentina. Due to currency controls and extreme inflation in this region, many merchants face significant risks when doing business with overseas customers. High credit card processing fees and currency conversion rates can result in losses of 30-50% for some merchants. For these reasons, many merchants in Latin America prefer to receive payment for services in distributed ledger digital asset (e.g., bitcoin) rather than fiat money asset (e.g., government currency, such as pesos). LPS subsystem 10 may be operative to serve this market by enabling its merchant clients to receive distributed ledger digital asset (e.g., bitcoins) in payment for their services, even when their customers may not have such distributed ledger digital asset without agreeing to a loan with such distributed ledger digital asset as a loan payout and with a loan payoff being paid in fiat money asset (e.g., government currency, such as by a customer credit card). As mentioned, software or data structure 15 or any other suitable component(s) of LPS subsystem 10 may be operative to act as a payment processing service layer that may work in the following manner: (i) a merchant contracts with LPS subsystem 10 to use its service and incorporates the software of LPS subsystem 10 into the merchant's website or app or other suitable merchant-customer interface; (ii) a customer that wishes to reserve a hotel room or purchase a product of the merchant may do so using the website by forming a loan agreement whereby the customer agrees to payoff a loan in fiat money asset or government currency (e.g., via a credit card in the same manner as any other online credit card transaction); (iii) instead of paying the merchant, the software of LPS subsystem 10 may be operative to direct the customer client (e.g., a credit card processor or other payment instrument of the customer client) to pay LPS subsystem 10 one or more loan payoffs according to the agreed upon loan; (iv) LPS subsystem 10 may be operative to send to the merchant a number of distributed ledger digital asset (e.g., bitcoins) equal to the value of the fiat money asset or government currency paid or to be paid by the customer (notwithstanding any loan agreement fees due to the LPSP); and (v) once the merchant receives the distributed ledger digital asset (e.g., bitcoins), it can hold them, spend them, or convert them into local currency (e.g., fiat money asset or government currency). The distributed ledger digital asset (e.g., bitcoins) paid by LPS subsystem 10 to the merchant may not come from the customer. LPS subsystem 10 may instead purchase the distributed ledger digital asset (e.g., bitcoins) regularly from various distributed ledger digital asset (e.g., bitcoin) sellers (e.g., client subsystem 100a), and may pay for them with its own funds in advance of any merchant transaction and/or in advance of any customer loan agreement (e.g., before (i) or (ii) or (iii) or (iv) described above). Thus, LPS subsystem 10 may be operative to store a cache of distributed ledger digital asset (e.g., bitcoins) sufficient to settle upcoming transactions, and may take on any risk that the value of the distributed ledger digital asset may drop during that time. In some embodiments, payments made by LPS subsystem 10 may only flow to the merchant, so the merchant's customer may not direct their payments to any other destination. LPS subsystem 10 may only send the merchant sufficient value to complete the transaction, so it may be operative to never transfer any more value to the merchant than required for the purchase of the good or service. LPS subsystem 10 may be operative to already possess the distributed ledger digital asset (e.g., bitcoins) required to pay the merchant prior to any transaction with a customer, so LPS subsystem 10 may not be exchanging the customer's money for distributed ledger digital asset (e.g., bitcoins). Indeed, the service provided by LPS subsystem 10 may be at least partially transparent to the merchant's customers.

### Description of FIG. 3

FIG. 3 is a flowchart of an illustrative process 300. At operation 302, a LPS subsystem may be operative to obtain a distributed ledger digital asset from a centralized or decentralized distributed ledger digital asset network subsystem. For example, LPS subsystem 10 may be operative to receive 10 bitcoin or 10 Citicoin from one or more distributed ledger digital asset network subsystems 100a. At operation 304, the LPS subsystem may be operative to receive a loan request from a customer client subsystem. For example, LPS subsystem 10 may be operative to receive a request for a loan from a customer client subsystem 100b (e.g., directly or via a merchant client subsystem 100d that may be facilitating a transaction with the customer), where the loan request may be indicative of any suitable information, including, but not limited to, a requested loan payout amount (e.g., a loan principal amount) in any suitable currency (e.g., any suitable amount of any suitable distributed ledger digital asset (e.g., 8 bitcoin) and/or any suitable amount of any suitable fiat money asset (e.g., U.S. dollars or pesos), which may be equal to the value of a good or service of a customer/merchant transaction or may be unassociated with any customer/merchant transaction), any suitable data indicative of any other suitable characteristics of the desired loan (e.g., any down payment amount, any loan term, any loan payment period (e.g., monthly or weekly loan payoff periods), any loan payoff currency (e.g., any suitable fiat money asset (e.g., U.S. dollars or pesos), any suitable data indicative of any suitable characteristics of a customer client that may be useful for determining a credit score of the customer client (e.g., tax identification number, social security number, bank account information, date of birth, full name, unique customer client identifier with the LPSP, etc.), any suitable data indicative of a merchant good or service to be purchased by the customer client with at least a portion of the requested loan payout amount (e.g., if a customer/merchant transaction is associated with the loan request), and/or the like. At operation 306, the LPS subsystem may be operative to determine a loan structure based on the received loan request. For example, LPS subsystem 10 (e.g., alone or in conjunction with the customer client and/or any merchant client of any associated customer/merchant transaction and/or any third party subsystem (e.g., a credit check service provider)) may be operative to receive a loan request from a customer client and determine an acceptable loan structure with any acceptable terms for a loan agreement with the customer client (e.g., form an enforceable loan agreement) based on the received loan request (e.g., a loan with a loan payout of a particular value of a particular distributed ledger digital asset and with a loan payoff of a particular value of a particular fiat money asset over a particular loan payoff schedule, where the loan may or may not include on a required customer down payment or may or may not be based at least partially on the value or type of any merchant good/service of a customer/merchant transaction that may be associated with the loan and/or on a requirement that at least a portion of the loan payout be transmitted by the LPSP to such a merchant if there is such an associated transaction). At operation 308, the LPS subsystem may be operative to transmit at least a portion of the distributed ledger digital asset from the LPS subsystem to a merchant client subsystem and/or to the customer client subsystem based on the determined loan structure. For example, LPS subsystem 10 may be operative to transmit at least a portion (e.g., 8 bitcoin) of the 10 bitcoin received from one or more distributed ledger digital asset network subsystems 100a to a merchant client subsystem 100d and/or to the customer client subsystem 100b based on the determined loan agreement (e.g., as at least a portion of a loan payout of the loan agreement). At operation 310, the LPS subsystem may be operative to receive a fiat money asset from the customer client subsystem (e.g., directly or in conjunction with an associated fiat money asset network subsystem) based on the determined loan structure. For example, LPS subsystem 10 may be operative to receive from a customer client subsystem 100b and/or from a fiat money asset network subsystem 100c associated with the customer client (e.g., credit card payment data) a fiat money asset (e.g., U.S. dollars) based on the determined loan agreement (e.g., as at least a portion of a loan payoff of the loan agreement).

It is understood that the operations shown in process 300 of FIG. 3 are only illustrative and that existing operations may be modified or omitted, additional operations may be added, and the order of certain operations may be altered.

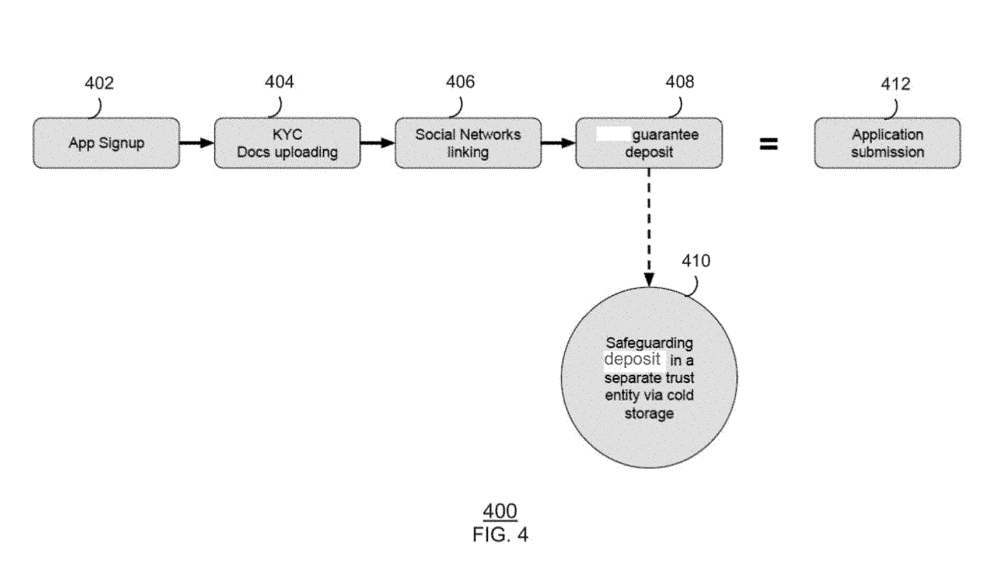

### Description of FIGS. 4-7

FIGS. 4-7 are flowcharts of illustrative processes that may be used to enhance process 300 of FIG. 3 by utilizing a distributed ledger digital asset as collateral during the loan processing service. For example, the loan request generation and communication to LPS subsystem 10 (e.g., from customer client subsystem 100b) of operation 304 of process 300 may also include a customer providing an initial deposit as collateral for the loan being requested. As shown in FIG. 4, a process 400 may be used to submit the loan request of operation 304 of process 300 or otherwise. As shown, at operation 402, a customer may sign-up for an app or other portal to LPS subsystem 10 (e.g., an application 119 if customer subsystem 100b). At operation 404, the customer may upload (e.g., via the app) any suitable “know your customer” (“KYC”) documents that may be useful by LDS subsystem 10 for determining whether or not to provide a requested loan, such as identity proving documents (e.g., passport, driver's license, etc.), address proving documents (e.g., utility bill, etc.), and/or the like. At operation 406, a customer may link one or more of its social network profiles to enable LDS subsystem 10 or other entity to gather any suitable data for creating a credit score for the customer. At operation 408, a guarantee deposit may be made by the customer to any suitable holding company (e.g., a separate trust entity 410 (e.g., via cold storage)). Such a deposit may be an initial deposit of a distributed ledger digital asset (e.g., bitcoin (e.g., BTC)) and/or of a fiat money asset as a guarantee for the credit line being requested and may be of any suitable value (e.g., any suitable percentage of the credit line being requested or the like). At operation 412, proof of the deposit may be provided along with any of the information gathered as part of a submission of an application for the loan. It is understood that the operations shown in process 400 of FIG. 4 are only illustrative and that existing operations may be modified or omitted, additional operations may be added, and the order of certain operations may be altered.

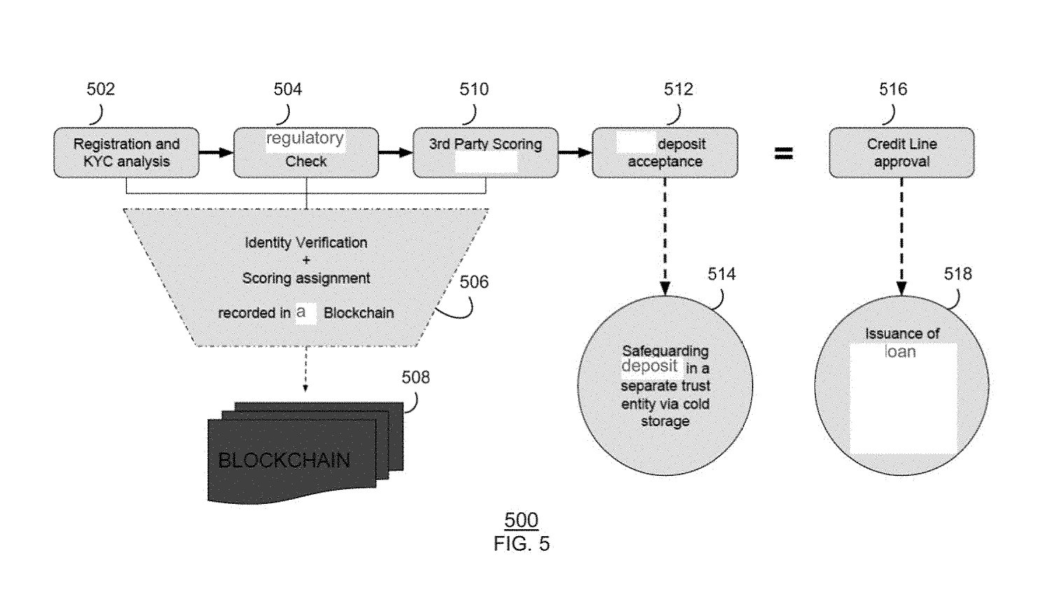

As shown in FIG. 5, a process 500 may be used to verify customer identification and score the loan request of process 400 and/or of the loan request of operation 304 of process 300 or otherwise (e.g., as a portion of operation 306 of process 300). At operation 502, LDS subsystem 10 may register the customer and analyze (e.g., process) the KYC data of operation 402. At operation 504, the Office of Foreign Assets Control (“OFAC”) of the U.S. Department of the Treasury and/or any other suitable regulatory and/or governmental entity may be used by LDS subsystem 10 to check any suitable customer loan request data. At operation 510, any suitable third party credit scoring and/or identity verification entity, such as Lenddo, may be used by LDS subsystem 10 to analyze any suitable customer loan request data (e.g., social network data or otherwise). Any processing of one, some, or each of operations 502, 504, and 510 may include identity verification and/or scoring assignment and/or recordation in a blockchain 508 (e.g., any suitable distributed ledger technology (e.g., sidechain technology with public or private networks and/or alternate blockchains within public or private environments) at operation 506. For example, operations 502, 504, 506, and/or 510 may include performing a customer due diligence to verify the identity, run sanction checking, and/or validate the origin of the deposited funds (e.g., BTC funds or otherwise) of operation 408 of process 400. Once the identity is confirmed, that identity and/or an initial credit risk scoring and/or any suitable underwriting data and/or any suitable credit line usage and/or customer behaviors may be registered on a blockchain 508. At operation 512, if/when a loan request is approved, the guarantee deposit funds of operation 408 of process 400 may be accepted as collateralization of the loan being issued, where that deposit may be safeguarded at any suitable holding company (e.g., a separate trust entity 514 (e.g., via cold storage), which may be the same or different than entity 410 of process 400). As mentioned, such a deposit may be an initial deposit of a distributed ledger digital asset (e.g., bitcoin (e.g., BTC)) and/or of a fiat money asset as a guarantee for the credit line being requested and may be of any suitable value (e.g., any suitable percentage of the credit line being requested or the like). At operation 516, the loan request may be approved and, at operation 518 the loan may be provided to the customer or to an applicable merchant (e.g., similarly to operation 308 of process 300). For example, operation 518 may include issuance of a BTC wallet and/or a debit card (e.g., a Visa debit card) to the customer (e.g., at customer subsystem 100b) and/or to a particular merchant that may be associated with the loan. The service may allow a credit line to the customer in fiat (e.g., a centralized monetary system) that can be used to pay in any suitable installments (e.g., 1, 3, and 6 installments to any merchants by using bitcoin (e.g., a decentralized monetary system) or using a debit card mechanism. It is understood that the operations shown in process 500 of FIG. 5 are only illustrative and that existing operations may be modified or omitted, additional operations may be added, and the order of certain operations may be altered.

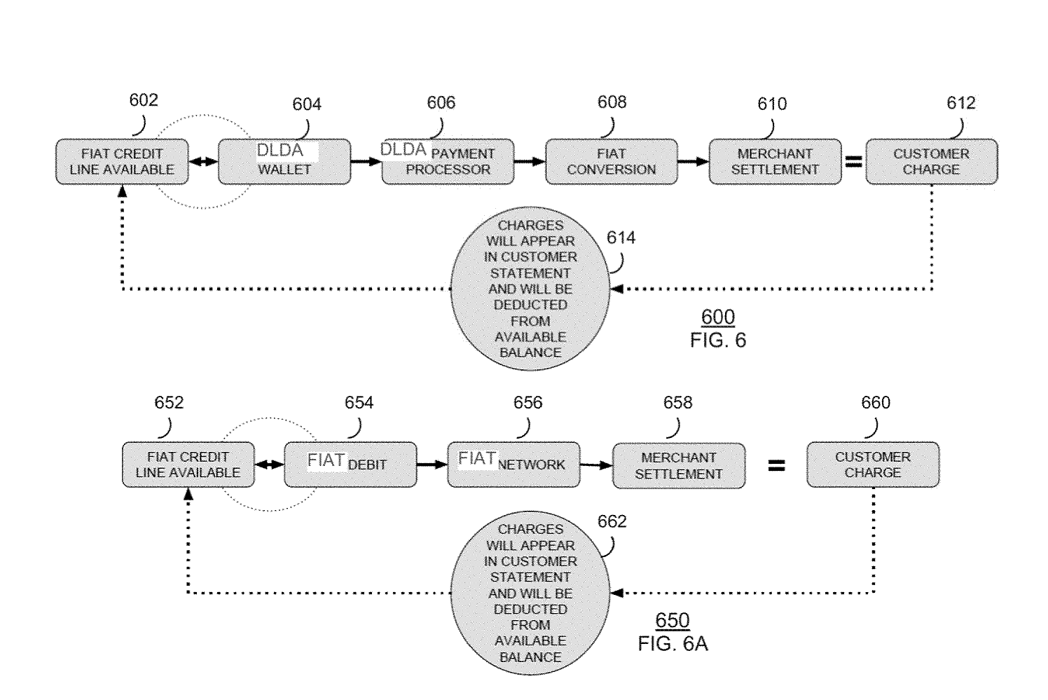

As shown in FIG. 6, a process 600 with operations 602, 604, 606, 608, 610, 612, and 614 may be used to utilize a loan (e.g., as a portion of operation 308 of process 300) where the credit line may be issued in fiat money assets but can be used to buy distributed ledger digital assets for use with merchants at which such distributed ledger digital assets may be accepted as a payment method and the amount of purchase may be converted automatically in distributed ledger digital assets at the time of the payment, where all charges in the account may be made in fiat money assets. It is understood that the operations shown in process 600 of FIG. 6 are only illustrative and that existing operations may be modified or omitted, additional operations may be added, and the order of certain operations may be altered. Alternatively or additionally, as shown in FIG. 6A, a process 650 with operations 652, 654, 656, 658, 660, and 662 may be used to utilize a loan (e.g., as a portion of operation 308 of process 300) where the credit line may be issued in fiat money assets and fiat money assets may be used by paying with a debit mechanism associated with the account (e.g., fiat network (e.g., a Visa Network)) (e.g., if a merchant does not accept distributed ledger digital assets), where all charges in the account may be made in fiat money assets. It is understood that the operations shown in process 650 of FIG. 6A are only illustrative and that existing operations may be modified or omitted, additional operations may be added, and the order of certain operations may be altered. There may be a monthly statement provided that may list consumer charges plus previous unpaid balance (e.g., if there was any) and any involved fees. The customer may be able to pay their current balance via fiat money assets (e.g., U.S. Dollars) and/or distributed ledger digital assets (e.g., BTC) and/or tether dollars (“USDT”) and/or the like via system 1.

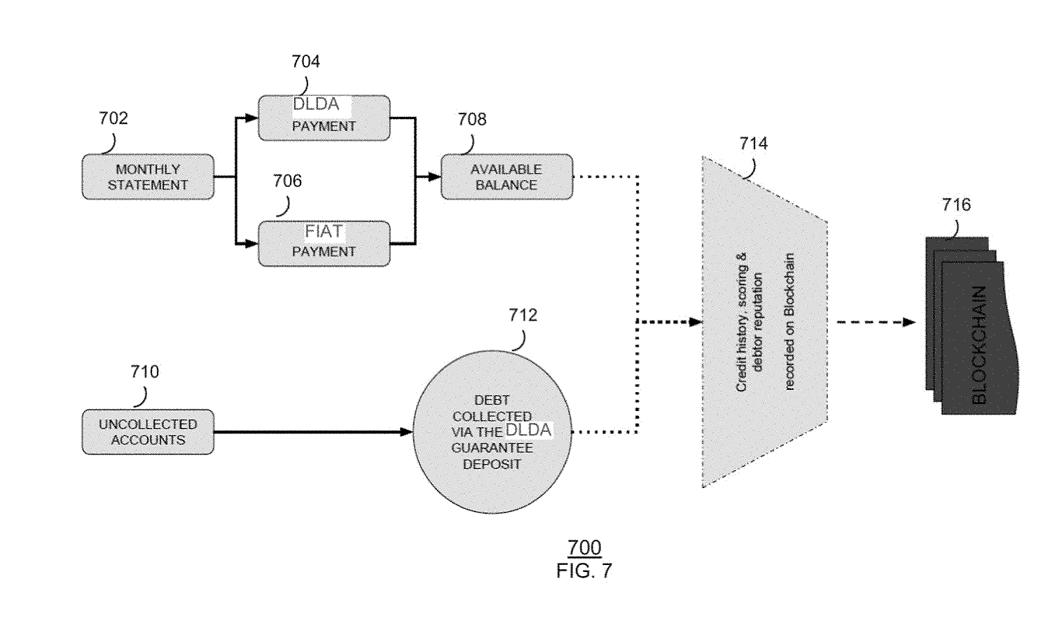

As shown in FIG. 7, a process 700 may be used to collect loan payments (e.g., as a portion of operation 310 of process 300). At operations 702, 704, 706, and 708, a monthly statement that may include all the charges made by the customer may be expressed in legal tender currency and may be paid back with fiat money assets and/or distributed ledger digital assets and/or the like. At operations 710 and 712, in case the account may be placed for default, the debt may be paid by deducting the amount from the initial guarantee deposit made during the loan application request. At operation 714, the customer (e.g., debtor) reputation including defaults may be recorded in a distributed ledger of a decentralized monetary system (e.g., blockchain 716) that may be publicly accessed by any other suitable third party entity. For a customer that defaults, the balance may be refinanced. For uncollectible accounts, the debt could be paid using the initial secured deposit which was requested at the credit line application, and the reputation as bad debtor may be recorded in the Blockchain identity associated to that customer, which could then be checked by any other approved financial provider. It is understood that the operations shown in process 700 of FIG. 7 are only illustrative and that existing operations may be modified or omitted, additional operations may be added, and the order of certain operations may be altered.

### Further Description of FIGS. 1-7

It is also understood that a customer client subsystem 100b may be operative as any suitable distributed ledger digital asset network subsystem (e.g., any subsystem 100a) for sending or receiving any suitable distributed ledger digital asset and/or as any suitable fiat money asset network subsystem (e.g., any subsystem 100c) for sending or receiving any suitable fiat money asset. Similarly, it is also understood that a merchant client subsystem 100d may be operative as any suitable distributed ledger digital asset network subsystem (e.g., any subsystem 100a) for sending or receiving any suitable distributed ledger digital asset and/or as any suitable fiat money asset network subsystem (e.g., any subsystem 100c) for sending or receiving any suitable fiat money asset.

One, some, or all of the processes described with respect to FIGS. 1-7 may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 and/or data structure 15 of FIG. 1 and/or memory 113 of FIG. 2). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from a LPS subsystem to a client subsystem, from a client subsystem to a LPS subsystem, and/or from one client subsystem to another client subsystem using any suitable communications protocol (e.g., the computer-readable medium may be communicated to a client subsystem 100 via communications component 14/114 (e.g., as at least a portion of an application 119)). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any, each, or at least one module or component or subsystem of the disclosure may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

While there have been described systems, methods, and computer-readable media for a loan processing service utilizing a distributed ledger digital asset as collateral, it is to be understood that many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method comprising:
obtaining at a loan processing subsystem a distributed ledger digital asset from a distributed ledger digital asset network subsystem;
receiving at the loan processing subsystem a loan request;
determining at the loan processing subsystem a loan structure based on the received loan request;
transmitting at least a portion of the obtained distributed ledger digital asset from the loan processing subsystem to at least one of a merchant client subsystem and a customer client subsystem based on the determined loan structure; and
receiving a fiat money asset at the loan processing subsystem from at least one of the customer client subsystem and a fiat money asset network subsystem based on the determined loan structure.

2. The method of claim 1, wherein the receiving the loan request comprises receiving the loan request at the loan processing subsystem from a customer client subsystem.

3. The method of claim 1, wherein the receiving the loan request comprises receiving the loan request at the loan processing subsystem from a merchant client subsystem.

4. The method of claim 1, wherein the received loan request is indicative of a guarantee deposit by a customer client subsystem.

5. The method of claim 4, wherein the guarantee deposit is a deposit distributed ledger digital asset.

6. The method of claim 4, wherein the guarantee deposit is a deposit fiat money asset.

7. The method of claim 1, wherein the transmitting comprises transmitting the at least a portion of the obtained distributed ledger digital asset from the loan processing subsystem to a merchant client subsystem based on the determined loan structure

8. The method of claim 1, wherein the transmitting comprises transmitting the at least a portion of the obtained distributed ledger digital asset from the loan processing subsystem to a customer client subsystem based on the determined loan structure.

9. The method of claim 8, wherein the receiving comprises receiving the fiat money asset at the loan processing subsystem from the customer client subsystem based on the determined loan structure.

10. The method of claim 8, wherein the receiving comprises receiving the fiat money asset at the loan processing subsystem from a fiat money asset network subsystem based on the determined loan structure.

11. The method of claim 1, wherein the receiving comprises receiving the fiat money asset at the loan processing subsystem from a customer client subsystem based on the determined loan structure.

12. The method of claim 1, wherein the receiving comprises receiving the fiat money asset at the loan processing subsystem from a fiat money asset network subsystem based on the determined loan structure.

13. The method of claim 1, wherein the obtaining the distributed ledger digital asset is completed before the receiving the loan request.

14. The method of claim 1, wherein the loan request comprises information indicative of:
a loan payout amount; and
a currency of the loan payout amount.

15. The method of claim 1, wherein the loan request comprises information indicative of:
a down payment amount; and
a currency of the down payment amount.

16. The method of claim 1, wherein the loan structure comprises information indicative of a customer client.

17. The method of claim 16, further comprising linking, at the loan processing subsystem, the information indicative of the customer client with the transmitted at least a portion of the obtained distributed ledger digital asset.

18. The method of claim 1, wherein the transmitting comprises transmitting the at least a portion of the obtained distributed ledger digital asset from the loan processing subsystem to a merchant client subsystem based on the determined loan structure.

19. A loan processor subsystem comprising:
a communications component; and
a processor operative to:
obtain, via the communications component, a distributed ledger digital asset from a first remote subsystem;
receive, via the communications component, a loan request;
determine a loan structure based on the received loan request;
transmit, via the communications component, at least a portion of the obtained distributed ledger digital asset to a second remote subsystem based on the determined loan structure; and
receive, via the communications component, a fiat money asset from a third remote subsystem based on the determined loan structure.

20. A non-transitory computer-readable medium comprising computer-readable instructions recorded thereon for:
obtaining at a loan processing subsystem a distributed ledger digital asset from a distributed ledger digital asset network subsystem;
receiving at the loan processing subsystem a loan request;
determining at the loan processing subsystem a loan structure based on the received loan request;
transmitting at least a portion of the obtained distributed ledger digital asset from the loan processing subsystem to at least one of a merchant client subsystem and a customer client subsystem based on the determined loan structure; and
receiving a fiat money asset at the loan processing subsystem from at least one of the customer client subsystem and a fiat money asset network subsystem based on the determined loan structure.
